(19) United States
(12) Patent Application Publication
(10) Pub. No.: US 2018/0132428 A1
(43) Pub. Date: May 17, 2018

(54) Building Structure, Building and Greenhouse

(71) Applicant: Juying FENG, Zhejiang (CN)

(72) Inventor: Juying FENG, Zhejiang (CN)

(21) Appl. No.: 15/571,943

(22) PCT Filed: May 6, 2015
(86) PCT No.: PCT/CN2015/078371

§ 371 Date: Nov. 6, 2017

(51) Int. Cl. A01G 9/14; E04B 1/12; E04B 1/61; E06B 1/60; E04C 2/54

(52) U.S. Cl. CPC A01G 9/14; E04B 1/12; E04C 2/54; E04B 1/61; E06B 1/60; E04B 1/54

(57) ABSTRACT

The present invention relates to a building structure and mainly solves the problem that it is inconvenient to install and adjust the panel and the framework component (column, beam, girder, etc.) connected by the fasteners in the existing building structure. The building structure comprises a building panel assembly and a framework assembly, the framework assembly comprises a plurality of beams, columns and girders connected with each other and the panel assembly comprises a plurality of panels, the panel is supported by the framework components. A dovetail joint is embedded on each panel and each framework component. The adjacent panels and/or the framework components are connected with each other by the dovetail joint, which makes the adjustment of positions thereof to be very convenient and also decreases the difficulty of installation. It is further disclosed a building adopting above-mentioned building structure which also has a door component and a window component connected to the panel and the framework using the dovetail joint, which makes the adjustment of the position of the door and the window to be very convenient, so as to fulfill various requirements. It is further disclosed a greenhouse adopting above-mentioned building structure with the panel made of transparent or translucent material, which is convenient to install and can be assembled into various shapes.

### Field of the Invention

The present invention relates to the field of architecture, specifically to a building structure, a building and a greenhouse.

### BACKGROUND OF THE INVENTION

In current various building structures, a building framework is commonly used. It is formed with columns, beams and girders, and is covered by building panels. Those panels can be curtain wall panels, decorative wall panels, insulation boards, roof panels, etc. Beams and columns are welded together, or are fixed by some fasteners. After the building framework is constructed, the panels will be attached to the framework. This construction method require large amount of labor and time due the following facts: 1. the structure is complicated, requiring a large variety of fasteners and consuming plenty of time and labor during construction process. 2. Over-sized parts make it hard to be transported and installed. 3. Lack of extensibility, structure is hard to modify or extend after the construction. 4. Dismantling and recycling is very difficult, causing wastes and pollution. Etc.

### SUMMARY OF THE INVENTION

The goal of the invention is to provide a building structure that is easy to assemble, and not costing large amount of fasteners.

The further goal of the invention is to propose a building structure that is easy to adjust, with high extensibility, and is able to be wholly recycled and reused.

The even further goal of the invention is to propose a building structure with a simple structural system, with high water-proof functionality.

The goal is achieved by following technical solutions:

A new building structure comprises a building panel assembly anti a framework assembly. The framework assembly comprises multiple connectable beams, girders and columns. The building panel assembly comprises various types of panels, those panels will be supported by the framework assembly. The feature of this structure is that all the panels and beams are embedded with the dovetail joint. Those parts are connected by the dovetail joint, forming the entire building structure.

In a preferred embodiment, the dovetail joint system has an insert and a slot. The connection between the panels and the framework components (columns, beams, girders, etc.) is achieved by connecting the insert and the slot.

In an embodiment, the insert is located at upwards or oblique upwards part of the building panels, as well as the framework components (columns, beams, girders, etc.). The adjacent panel or part will have a slot to connect the insert from bottom-up straight or obliquely.

In a preferred embodiment, the dovetail joint will be sealed after being connected.

In an embodiment, the sealing structure is located at the surface of the dovetail joint, using a flexible material coating or a sealing strip.

In a preferred embodiment, the position of the insert within the slot can be adjusted by sliding the insert through the slot. This makes the position between the two connected building panels or framework components (columns, beams, girders, etc.) adjustable.

In an embodiment, the building structure also comprises a type of fixture, which is used to fix the position between panels and framework components (columns, beams, girders, etc.).

In a preferred embodiment, the building structure also comprises a type of crosspiece. The crosspiece also has the dovetail joint system, and will be used between the vertically installed panels. The both ends of the crosspiece can be connected to the beams, and can be adjusted through sliding.

In an embodiment, there will be a reinforcement structure on the crosspiece.

The goal of the invention is also to provide a new type of building which adopts above building structure.

In a preferred embodiment, the building further comprises a window assembly. The window assembly comprises window glazing and window frames. The window frames are connected with the mentioned building panels and framework through the dovetail joint. The window glazing will be installed onto the window frames.

In an embodiment, the building further comprises a door assembly. The door assembly includes doors and door frames. The door frames are connected with the mentioned building panels and framework through the dovetail joint. The doors will be installed onto the door frames.

Through the connection between the door/window assembly and the building panels/framework, user can freely adjust the size and the position of the windows and the doors on the building. It is also easier to reduce or increase the amount of doors and windows according to the needs.

The goal of the invention is also to provide a greenhouse which adopts above-mentioned building structure. The feature of the greenhouse is to comprise a building panel that has a light transmitting portion which is made of transparent or translucent materials.

In an embodiment, the greenhouse building panel comprises a panel frame and a light transmitting panel. The mentioned dovetail joint is located at the four sides of the panel. The light transmitting portion is embedded within the panel frame. By locating the dovetail joint onto the panel frame instead of the relatively thinner light transmitting panel, the strength of the panel itself is improved.

In a preferred embodiment, the greenhouse further comprises a window assembly. The window assembly comprises window glazing and window frames. The window frames are connected with the mentioned building panels and framework components through the dovetail joint. The window glazing will be mounted onto the window frames.

In an embodiment, the greenhouse further comprises a door assembly. The door assembly includes doors and door frames. The door frames are connected with the mentioned building panels and framework through the dovetail joint. The doors will be mounted onto the door frames.

Through the connection between the door/window assembly and the greenhouse panels/framework, user can freely adjust the size and the position of the windows and the doors on the greenhouse. It is also easier to reduce or increase the amount of doors and windows that the greenhouse needs.

### BRIEF DESCRIPTION OF THE DRAWINGS

FIG. 1 is a perspective view of the embodiment of the present invention;

FIG. 2 is a side view of the embodiment of the present invention;

FIG. 3 is a top sectional view of the embodiment of the present invention;

FIG. 4 is a side sectional view of the embodiment of the present invention;

FIG. 5 and FIG. 6 are mounting structural diagrams of the door of the present invention;

FIG. 7 is a structural diagram of the light transmitting panel of the embodiment of the present invention;

FIG. 8 and FIG. 9 are structural diagrams of the support frame of the embodiment of the present invention.

To make clearer about the problems this invention is solving, the techniques this invention has adopted as well as the effect this invention has achieved, the technical solutions of the embodiments of the present invention will be described in conjunction with the drawings in details below. Obviously, the described embodiments are only one portion but not all of the embodiments of the present invention. All other embodiments which can be obtained by those skilled in the art based on the embodiments of the present invention without paying any inventive labor all fall into the protection scope of the present invention.

### Embodiment 1

The building components in this invention mainly consists of a building panel assembly and a framework assembly. The building panel assembly in general comprises at least one building panel. The framework assembly in general comprises at least one framework component (beam, column, girder, etc.). In this embodiment, the panel can be curtain wall panels, decorative wall panels, insulation boards, roof panels, ceiling panels or any other types of building panels. The shape of those panels can be planar surface, curved surface, or surface with various outlines such as polygon, circle and oval. The framework assembly can comprise a beam, a girder, a column or any other parts that perform structural supportive functionality. The building panel assembly will be installed and attached to the framework assembly, and will be supported by the framework assembly.

Wherein, the panels and the framework components (columns, beams, girders, etc.) all have the dovetail joint system embedded. The dovetail joint connects the adjacent panels and framework components (columns, beams, girders, etc.). Specifically, the adjacent beams and columns connect each other to form a close or semi-close frame, where one or multiple panels are installed. The connection between the frame and the panel is achieved by the dovetail joint, as well as the connection between the panels. The entire structure is connected by the dovetail joint. This method largely eases the difficulty of construction and dismantles, reduces the construction waste, thus contributes to the environment.

When the building needs to be extended, the new components will just need to be connected to the existing building using the dovetail joint. This offers the building a high extensibility and flexibility.

This dovetail joint system comprises an insert and a slot. Preferably, the insert has a convex block. This convex block can be a strip of a continuous convex block, a plurality of spaced arranged convex blocks, or a combination of convex blocks and concave slots. The insert and the slot are arranged on connection surface on the periphery of the panel and the framework components, and components are connected with each other through the convex blocks and concave slots of the adjacent components.

Preferably, the size of convex block and concave slot does not necessarily to be a match. The length of the concave slot can be longer than the length of the convex block, thus the position of the convex block can be adjusted, making its connected parts adjustable. More specifically, the position between the panels, and between the panels and the columns are adjustable. This will make the structure highly flexible. User can construct different type of buildings according to different needs.

On the contrary, the length of the convex block can also be longer than the concave slot. For example, when a framework component (column, beam, girder, etc.) is connected to multiple building panels, the length of the convex block on the framework component (columns, beams, girders, etc.) will be longer than the length of the concave slot on each panel.

Preferably, any side of the building panel and the framework component (column, beam, girder, etc.) has both a continuous convex slot and a continuous concave block (the length of the concave slot and convex block may vary depend on the size thereof). The concave slot and the convex block are joined up and converted at any corner of the panel or the framework component (column, beam, girder, etc.).

Preferably, to ensure the firmness of the structure, the end of the connected component is fixed by the fastener after the adjustment of position of the adjacent components. The fastener can be of any existing types such as bolt-nut, rivet, screw and pin. Other joint methods such as gluing or welding can be adopted as well. It can also adopt the combination of fastener and various ways such as gluing and welding.

Preferably, the fastener joints will only be used between the framework components (columns, beams, girders, etc.), the connection between building panels and the framework components will be achieved by the dovetail joint. The framework components only bear the loads from the panel, and limit the panel's position through the dovetail joint. The building panel can slide along the dovetail joint, applying the gravity loads towards the bottom panel. The bottom panel will bear the loads from upper panel as well as the loads coming from the entire structure beyond it. In contrast with the conventional construction method, where the building panel is merely attached to the framework, while the framework bears all the loads of the building, the present invention allows the building panels to bear the building loads as well, thus balancing the loads from the building framework. This method improves the building's stability, especially when the building encounters extreme natural condition such as snow storm, wind storm or earthquake.

Preferably, when the length of a column is too long, it is necessary to install multiple panels along the vertical direction. The overall structure strength will be lowered by merely using the dovetail joint to connect those panels. To solve this problem, the crosspiece will be used between those panels. The top and bottom side of the crosspiece have both dovetail joints embedded, to connect its upper and lower panels respectively. The position of the upper panel and the lower panel is adjustable according to the crosspiece, meanwhile the both ends of the crosspiece can also be connected to the dovetail joints on the columns. The connection with the columns is not fixed but slidable, thus avoids the distribution of the forces through this connection, and reduces the loads for the columns.

The benefits of the crosspiece are the followings: 1. Easy to install and to dismantle. As compared with the structure in which the upper and lower row of panels are directly connected piece by piece, the application of the crosspiece can arrange the layout of all the panels, making it possible to install or to dissemble the panels as a whole in a row. 2. It increases the overall strength of the building panels, distributes the loads from the panels to the columns, and increases the overall stability of the building.

Moreover, it is also possible to apply reinforced structure onto the crosspiece, such as stiffener, or high-strength bracket, etc. This can improve the overall building stability without changing any panels on the building.

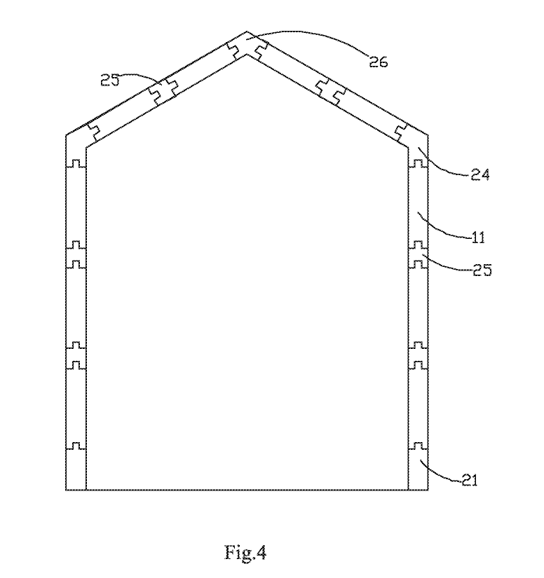

In order to improve the rainproof performance, as is shown in FIG. 4, the convex block of the dovetail joint will always locate at the upper side of the building panels or the framework components. The concave slot will be inserted upwards or oblique upwards into the slot from below when it needs to connect the component from the vertical direction. This is to ensure that direction of the concave slots will always face towards bottom. This method decreases the deposition of the rain and reduces the interference of the rain to the building such as moldy or leaking.

In order to improve he sealing performance of the building, a sealing structure can be provided at the connecting position between the insert and the slot. The sealing structure can adopt a flexible material coated on the joint surface. This flexible material coating can be of the types that can enhance sealing performance, such as rubber and resin. Alternatively, a sealing slot, together with a sealing strip can be provided on the joint surface, which can improve the sealing performance as well as the sound insulation performance. In addition to enhance the sealing performance, the sealing structure can also facilitate the firmness of the dovetail joints. By using the flexible material coating and/or the sealing strip, it can achieve an interference fit between the insert and the slot, which makes the insert more firmly when inserted into the slot and improves the strength of the structure. Meanwhile, it can prevent the components from rigidly colliding with each other. It can also avoid gaping and damaging caused by expansion and contraction thereof due to extraneous factors such as temperature and humidity.

### Embodiment 2

The building in this embodiment mainly adopts the same building structure in Embodiment 1. In architecture, the building is commonly provided with door and window other than the building panels and the framework. In order to match with the building panels and the framework components (columns, beams, girders, etc.) from the Embodiment 1, the door and the window in this invention also adopt the dovetail joints system so that no fixed installing position needs to be pre-determined. The installing position can be decided flexibly according to the on-site requirements.

Specifically, the building comprises a window assembly which comprises a window glazing and a window frame, the window frame is connected to the panel and/or the beam by the dovetail joint and the window glazing is mounted onto the window frame. By adjusting the dovetail joint structure on the window frame, the window assembly can be easily connected to the building panels and the framework components (columns, beams, girders, etc.). Meanwhile, the relative position of the insert and the slot of the dovetail joint is adjustable, this makes it possible to freely adjust the size, the number and the position of the windows on the building, thus expands the applicability of the building.

Specifically, the building comprises a door assembly which comprises a door and a window frame, the door frame is connected to the panel and/or the beam by the dovetail joint and the door is mounted onto the door frame. By adjusting the dovetail joint structure on the door frame, the door assembly can be easily connected to the building panels and the framework components (columns, beams, girders, etc.). Meanwhile, the relative position of the insert and the slot of the dovetail joint is adjustable, this makes it possible to freely adjust the size, the number and the position of the doors on the building, thus expands the applicability of the building.

Preferably, the size of the window assembly and the door assembly is proportional to that of the panel. By doing so, only corresponding number of panels need to be replaced when it needs to increase or decrease the number of the widow assembly or the door assembly or change the size thereof. This is an approach of the modular construction method which facilitate the extensibility of the architecture.

### Embodiment 3

Embodiment 3 is about a specific application of the present invention—a greenhouse which adopts the building structure in Embodiment 1 and 2. Because a greenhouse itself requires a good light transmitting condition, the building structure in this embodiment also comprises a type of building panel which has a light transmitting portion made of transparent or translucent materials. This type of panel allows the light to pass through to match the requirement of sunlight for the greenhouse. The beams, columns, doors, windows and other components can be manufactured in various materials such as wood, WPC, plastic, resin or metal to accommodate the climate and social environment of the user location.

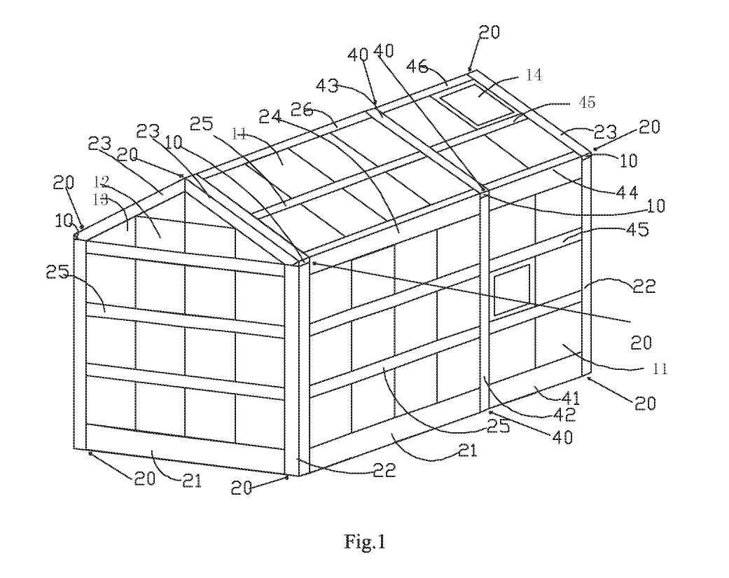

FIG. 1 is a perspective illustration of the greenhouse structure. The components of the greenhouse mainly comprise light transmitting panel, supporting frame, fastener and extension frame. The light transmitting panel is a type of building panel. The supporting frame and the extension frame are both different types of the building framework.

The light transmitting panel comprises square module 11, rectangular module 12 and triangular module 13. The supporting frame comprises bases 21, vertical frames 22, oblique frames 23, side frames 24 and roof frames 26. The extension frame comprises extension bases 41, extension vertical frames 42, extension oblique frames 43, extension side frames 44 and extension roof frames 46. The base, supporting frame, crosspiece of the supporting frame and extension frame are all subordinate examples of the building framework components of the present invention, however the framework components of the present invention includes but is not limited to above implementations. The extension frame is used as an extension structure and is not necessary in this framework.

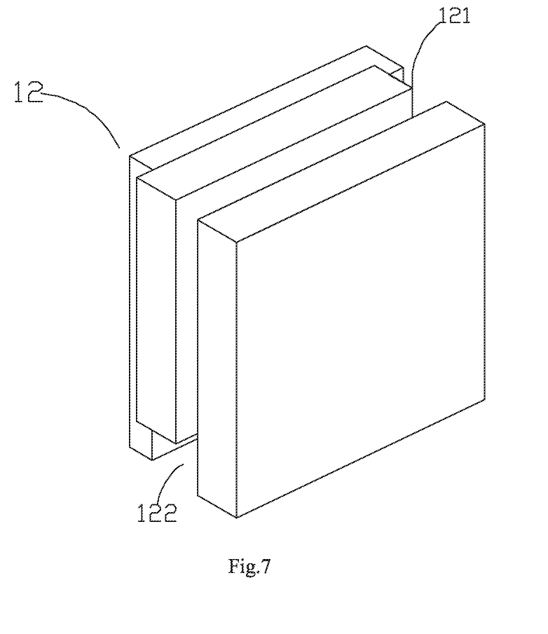

In this embodiment, for the square block 11 and rectangle module 12 (refer to FIG. 7), a convex block 121 can be provided on the upwards surface and one of the side surfaces of the module. The concave slot 122 will be placed at the bottom surface and the other side surface of the module. The convex block can be provided on the triangle module's one or both side surfaces facing upwards and the concave slot can be provided on the triangle module's one or both side surfaces facing downwards. The shape of the light transmitting module is not limited to rectangle or triangle, but can be any polygon shapes such as circle, oval or other irregular geometries. The light transmitting module can have a planar surface, or a curved surface. The surface can have some concave or convex portions. The square module 11 and the rectangle module 12 can be integrally molded using transparent or translucent material. They can also be manufactured by installing the transparent or translucent panel into a frame enclosure, fixed by concave slots and convex blocks on the frame.

The light transmitting module can have one light transmitting layer or have multiple light transmitting layers arranged in parallel.

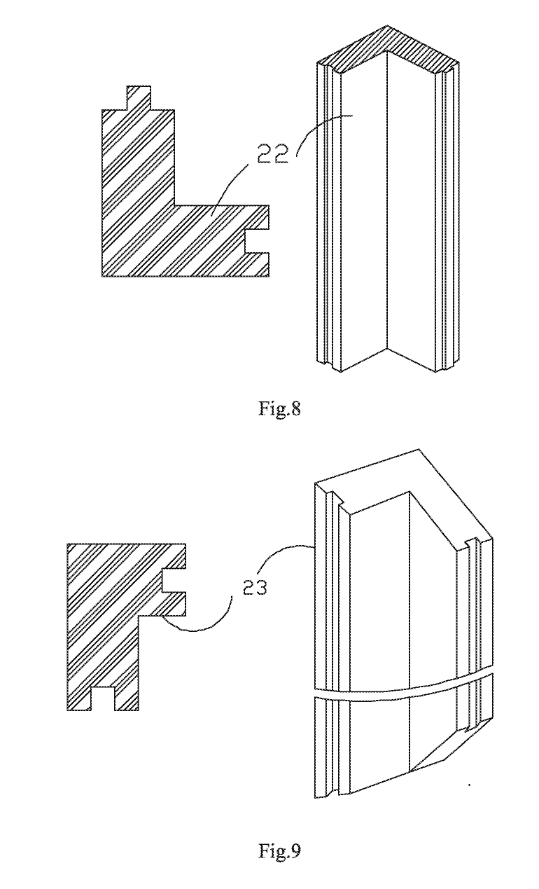

The supporting frame comprises bases 21, vertical frames 22, oblique frames 23, side frames 24 and roof frames 26. The adjacent components are connected with each other by dovetail joints, refer to FIG. 8 and FIG. 9 for detail structure. Preferably, the position of the insert relative to the slot is adjustable so that it is more convenient to adjust the position of the joint between columns and beams. After the position is decided, the joint can be fixed using fasteners, such as bolt-nuts, rivet, screws and pins. In the present embodiment, the columns and beams can be fixed by fasteners, while two panels can be fixed by dovetail joints. This way can reduce the amount of fixing components needed, shorten the time of installation process, make both installing and dismantling much easier. It is also possible to fix all the components using fasteners.

Preferably, the fasteners are only used at the joint positions of the bases 21, the vertical frames 22, the oblique frames 23, the side frames 24 and the roof frames 26. The dovetail joints are used at the joint position of square modules 11, the rectangle modules 12 and the triangle modules 13. Through the dovetail joints, their positions are limited by the bases 21, the vertical frames 22, the oblique frames 23, the side frames 24 and the roof frames 26. In the structure of a traditional greenhouse, the light transmitting panels are all fixed onto the greenhouse's framework by the fasteners. The framework of the greenhouse bear the entire loads of the building. When the greenhouse needs to bear any large additional loads such as snowfall and so on, it is very easy to exceed structure's load capacity, causing the greenhouse to collapse. While in the present invention, the fasteners are only used to connect the base and the framework, the rest of the joints such as those between the crosspiece and the light transmitting panels, are all connected by the dovetail joints system. The base and the framework only limit the position of the light transmitting panels. Those panels can slide along the dovetail joint, applying the gravity force towards the bottom panels. The bottom panel will bear the force from upper panel as well as the loads coming from the entire structure on top of it. This method allows the building panels to share the building loads, thus balancing the loads from the bases 21, the vertical frames 22, the oblique frames 23, the side frames 24 and the roof frames 26. Compared to the current greenhouse structure, this greenhouse has a better stability, especially when it encounters extreme natural condition such as snow storm, wind storm or earthquake.

When the length of a column is too long, it is necessary to install multiple panels along the vertical direction. The overall structure strength will be lowered if merely using the dovetail joint to connect those panels. To solve this problem, as shown in FIG. 1, the crosspiece 25 will be used between those panels. The top and bottom surface of the crosspiece have both dovetail joints embedded, to connect its upper and lower panels respectively. The position of the upper panel and the lower panel is adjustable according to the crosspiece 25, meanwhile the both ends of the crosspiece 25 can also be connected to the dovetail joints on the vertical frames 22 or the oblique frames 23. This connection is not fixed but slidable, the crosspieces 25 may slide relative to the vertical frames 22 or the oblique frames 23, thus avoids the distribution of the forces towards the vertical frames 22 or the oblique frames 23, reduce he loads for of the vertical frames 22 or the oblique frames 23.

Moreover, it is also possible to apply reinforced structure onto the crosspiece 25, such as stiffener, or high-strength bracket, etc. This can improve the overall building stability without changing any panels on the building.

The extension frame comprises extension bases 41, extension vertical frames 42, extension oblique frames 43, extension side frames 44 and extension roof frames 46. It can also comprise extension crosspieces 45, see FIG. 1 for details. When the original building space needs to be extended, user only needs to increase the amount of corresponding extension frames. The extension frames and the original frames are also connected with each other by dovetail joints. By only replacing part of the original building structures and connecting the extension frames, the extension of the space can be achieved.

In addition, the greenhouse comprises door assemblies 31, 32, 33 and the window assemblies 14.

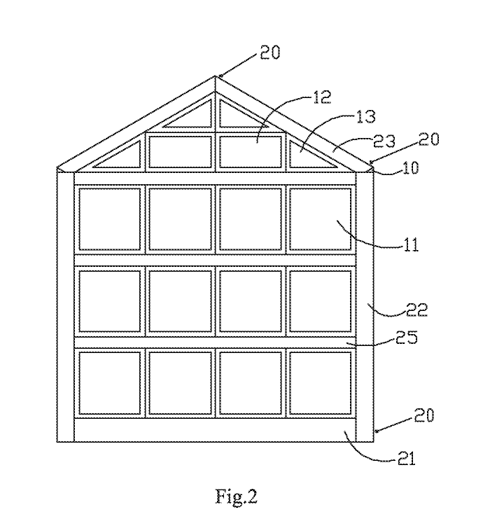

FIG. 2 illustrates an assembled schematic diagram of an elevation of the greenhouse, a crosspiece 25 is installed between rows of light transmitting panels from the top to the bottom to enhance the stability.

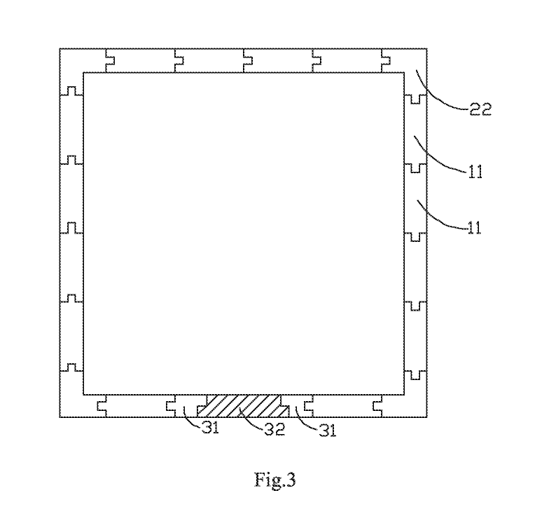

FIG. 3 is a sectional plan view of the greenhouse (not including longitudinal extension portion) which shows the horizontal structure of the greenhouse. The concave slots or convex blocks of all components circle in the same direction and forms a closed structure.

FIG. 4 is a longitudinal sectional view of the greenhouse which shows the vertical structure of the greenhouse. On the upwards or oblique upwards side of the panels and the framework components locate the convex block of the dovetail joints, the concave slot is located at the corresponding panels or framework components. When necessary, the convex block will be inserted upwards or oblique upwards into the concave slot from below. The advantage of doing so has been described in details in Embodiment 1 and the repetitious details need not be given here.

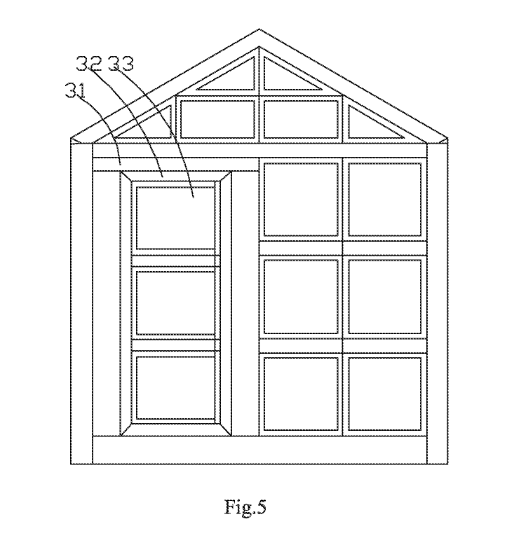

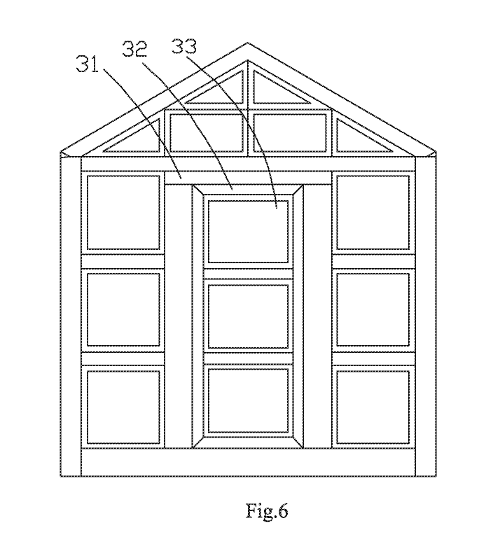

FIG. 5 and FIG. 6 are the schematic installation diagrams of the door assembly of the greenhouse. The height and width of the door assembly is designed corresponding to the size of other modules. The door assembly comprises a door and a door frame 31, the frame 31 is connected with the panel and/or beam through dovetail joint and the door is installed on the door frame.

The door may further comprise a door body frame 32 and a door body panel 33 and the door body panel may also be made of transparent or translucent materials. By embedding the dovetail joints with the door frame, the door assembly can be conveniently connected with the building panels and the framework components. Meanwhile, since the relative position of the insert and the slot of the dovetail joint is adjustable, user can freely change the size, number and position of the door in the building and thus, as shown in FIG. 5 and FIG. 6, to fulfill different requirements.

The installation method of the window assembly is similar to that of the door assembly, which has been described in details in Embodiment 1 and the repetitious details are not necessary. Compared with the light transmitting panels, the main purpose of the window assembly is that the window glazing of the window assembly can be open for ventilation and air circulation of the greenhouse.

FIG. 8 and FIG. 9 illustrate part of the design of the framework components used in the greenhouse, wherein the vertical frame 22 and the oblique frame 23 are designed to have an angled corner. Both sides of the angled corner may be provided with the convex block or the concave slot respectively. In order to fulfill the requirements of different types of greenhouse, the roof, the upper and lower surfaces of the oblique frames can also be customized as having an inclined angle. The particular angle can be determined according to the on-site requirements.

FIG. 3 and FIG. 4 illustrate various components of the greenhouse. Those components are manufactured to have a basic uniform thickness, which can maintain the consistency and aesthetics of the appearance of the building structure.

In the present embodiment, the crosspiece 25 is installed in horizontal direction to enforce the stability of greenhouse's facade, refer to FIG. 1 and FIG. 2. However, the crosspiece can also be installed in vertical direction.

In particular, the following steps can be followed when installing:

First step: assemble the bases 21 and the vertical frames 22 on the ground, and use corner fasteners 20 to fix the position, then finish the assembling of the light transmitting square modules 11, the window modules 14, the door assembly 31, 32, 33 and the crosspieces 25 of four facades;

Second step: install the side frames 24, the light transmitting triangle modules 13, the rectangle modules 12, the oblique frames 23 and the corners 10 in sequence, then install the roof frames 26 and fix it by the corner fasteners 20;

Last step: install the light transmitting modules 11 and window modules 14 on the roof and close the square modules guiding slots on the oblique frames.

The installation steps as mentioned above can be carried out in a reverse order if the greenhouse needs to be dismantled. All the components can be installed together in another place after dismantle.

Furthermore, those skilled in the art should be well comprehended, the figures provided here are only for the purpose of illustration and are not drawn to scale.

Meanwhile, it should be understood that example embodiments are provided so that this disclosure will be thorough, and will fully convey the scope to those who are skilled in the art. Numerous specific details (such as examples of specific components, devices and methods) are set to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known process, well-known device structures and well-known technology are not described in detail.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises”, “comprising”, “including” and “having” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on”, “directly engaged to”, “directly connected to” or “directly coupled to” another element or layer, there may he no intervening elements or layers present. Other words used to describe the relationship between elements should be interpreted in a like fashion (e.g., “between” versus “directly between”, “adjacent” versus “directly adjacent”, etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may he only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments. Further, unless otherwise specified, “a plurality of” in the description of the present invention means two or more than two.

Spatially relative terms, such as “inner”, “outer”, “beneath”, “below”, “lower”, “above”, “upper” and the like, may be used herein for ease of description to describe one element or feature's relationship to another element(s) or feature(s) as illustrated in the figures. It will be understood that spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The above description is just the preferred embodiments of the present invention, and it is not explained as any form limitation for the present invention. For those skilled in the art, various amendments or modifications may be made to the present invention. Any modification, equivalent substitution and improvement made in the spirit and principle of the present invention shall fall into the protection scope of the present invention.

1. A building structure comprising a building panel assembly and a framework assembly, the framework assembly comprising a plurality of components (columns, beams, girders, etc.) connected with each other and the building panel assembly comprising a plurality of panels, the panels being supported by the framework components, wherein a dovetail joint system is embedded on each panel and each beam, and adjacent panels, the panels and the framework components and/or adjacent components are connected with each other by the dovetail joints.

2. The building structure of claim 1, wherein the dovetail joint comprises an insert and a slot, which cooperated with each other. The adjacent panels, the panels and the framework components and/or the adjacent framework components are connected with each other by inserting the inserts into the slots.

3. The building structure of claim 2, wherein the panel and/or the framework components is embedded with an insert at the joint position from side surface, top surface, or top inclined surface. The corresponding panel and/or framework component which is intended to be connected with is embedded with a slot at the joint position. The insert is inserted upwards or oblique upwards into the slot from below.

4. The building structure of claim 2, wherein a sealing structure is provided at the connection position between the insert and the slot.

5. The building structure of claim 4, wherein the sealing structure is a coating of flexible material or a sealing strip embedded on the connection surface.

6. The building structure of claim 1, wherein the position of the insert in the slot can be adjusted by relative slide therebetween so that the relative position of the adjacent panels, the panels and the framework components and/or the adjacent components is adjustable.

7. The building structure of claim 6, further comprising a fastener for fixing the adjacent panels, the panels and the framework components and/or the adjacent components.

8. The building structure of claim 1, further comprising a crosspiece with the dovetail joints embedded thereon, the crosspiece is used between the upper and lower panels. The upper portion and the lower portion of the crosspiece are connected with the panel through the dovetail joint respectively. Both ends of the crosspiece are connected with the beam through the dovetail joint.

9. The building structure of claim 1, wherein a reinforcement structure is embedded on the crosspiece.

10. A building which adopts the building structure of claim 1.

11. The building of claim 10, further comprising a window assembly which comprises a window glazing and a window frame, the window frame is connected with the panel and/or the framework component through the dovetail joint and the window glazing is mounted onto the window frame.

12. The building of claim 10, further comprising a door assembly which comprises a door and a door frame, the door frame is connected with the panel and/or the framework component through the dovetail structure and the door is mounted on the door frame.

13. A greenhouse which adopts the building structure of any of claims 1, wherein the panel comprises a light transmitting portion made of transparent or translucent material.

14. The greenhouse of claim 13, wherein the panel comprises a panel frame and a light transmitting portion, the dovetail joint is provided on the outer periphery of the panel frame and the light transmitting portion is mounted with the panel frame to form the panel.

15. The greenhouse of claim 13, further comprising a window assembly which comprises a window glazing and a window frame, the window frame is connected with the panel and/or the framework component through the dovetail joint and the window glazing is mounted onto the window frame.

16. The greenhouse of claim 13, further comprising a door assembly which comprises a door and a door frame, the door frame is connected with the panel and/or the framework component through the dovetail joint and the door is mounted onto the door frame.
